(19) United States
(12) Patent Application Publication
(10) Pub. No.: US 2002/0133450 A1
(43) Pub. Date: Sep. 19, 2002

(54) Hypertext transfer protocol application programming interface between client-side trading systems and server-side stock trading systems

(76) Inventor: Douglas R. Deming, Kihei, HI (US)

Correspondence Address: Michael I. Kroll, 171 Stillwell Lane, Syosset, NY, 11791, US

(21) Appl. No.: 09/805,236

(22) Filed: Mar. 13, 2001

(51) Int. Cl. G06F 17/60

(52) U.S. Cl. 705/37; 705/36

(57) ABSTRACT

The present invention is a software program that modifies a client-side stock trading system fill orders to market orders that are transmitted to a remote broker trading system. The modification will synchronizing a users desktop trading system with a stockbrokers remote system.

The HTTP-API (hypertext transfer protocol application program interface) provides client side users with the ability to use the computer resources of a remote server computer to effect transaction processing and/or the transfer of information from one computer to another without having the absolute need for a web browser, plugins or software languages contained within the server system.

### BACKGROUND OF THE INVENTION

1. Field of the Invention

The present invention relates generally to online brokerage systems and, more specifically, to Hypertext Transfer Protocol Application Programming Interface (HTTP-API) for synchronizing a users desktop trading system with a stockbrokers remote system.

2. Description of the Prior Art

There are other computer software programs designed for Internet interfacing. Typical of these is U.S. Pat. No. 5,754,772 issued to Leaf on May 19, 1998.

Another patent was issued to Lewine on Jul. 21, 1998 as U.S. Pat. No. 5,784,565. Yet another U.S. Pat. No. 5,901,286 was issued to Danknick et al. on May 4, 1999 and still yet another was issued on May 18, 1999 to Wagner as U.S. Pat. No. 5,905,908.

Another patent was issued to Grate et al. on Sep. 21, 1999 as U.S. Pat. No. 5,956,483. Yet another U.S. Pat. No. 6,112,235 was issued to Spofford on Aug. 29, 2000. Another was issued to del Val on Oct. 3, 2000 as U.S. Pat. No. 6,128,653 and another was issued on Oct. 24, 2000 to Nichols et al. as U.S. Pat. No. 6,138,150 and still yet another was issued to Swales on Nov. 21, 2000 as U.S. Pat. No. 6,151,625.

### U.S. Pat. No. 5,754,772

### Inventor: Shawn T. Leaf

### Issued: May 19, 1998

A system which makes prior art On-Line Transaction Processing (OLTP) systems and their associated databases accessible using HyperText Transport Protocol (HTTP) interfaces. The response time for an on-line user seeking HTTP access to the transaction processing system is minimized by pre-establishing a transaction gateway client having a static connection to the transaction processing system. In addition, the HTTP access to the transaction processing system is available for multiple concurrent users. The system further provides a gateway that is independent of the underlying service provided by the transaction processor, whereby the same gateway client is capable of usage with different databases and operations thereon.

### U.S. Pat. No. 5,784,565

### Inventor: Donald A. Lewine

### Issued: Jul. 21, 1998

A method is disclosed for determining a user's identity and creating a virtual session using the HTTP protocol without modifying the protocol or changing its stateless nature.

### U.S. Pat. No. 5,901,286

### Inventor: Dan Danknick et al.

Issued: May 4, 1999

Process steps to provide communication between a web browser capable of initiating execution of a platform-independent segment of executable code and a peripheral having an HTTP server and an SNMP agent. A first packet is transferred to the HTTP server, and, in response, a file is transmitted to the web browser. The file contains a reference to a platform-independent segment of executable code. Upon processing the file, this code segment is requested from the HTTP server. After the web browser receives the executable code from the HTTP server, execution of the code segment is initiated in order to create an SNMP client. Execution of the code segment also causes a packet to be sent from the SNMP client to the SNMP agent in the peripheral. In response to this packet, information concerning the peripheral is transferred from the SNMP agent to the SNMP client.

### U.S. Pat. No. 5,905,908

### Inventor: Richard Hiers Wagner

### Issued: May 18, 1999

An open network system for supporting input/output (I/O) operations for non-standard I/O devices are disclosed. The system includes a server coupled to a plurality of I/O devices through an open network and an extended open system protocol that supports communication with devices that are not personal computers (PCS). These devices include magnetic stripe readers, check readers, smart card readers, credit card terminals, screen phone terminals, PIN pads, printers, and the like. The extended open network protocol includes tags which identify device and input operations and attributes which identify the location, data exchange method, and data variable names for the retrieval, acquisition, and submission of data between the server and I/O devices. Preferably, the open network protocol is implemented in a Hyper Text Transport Protocol (HTTP). Preferably, the system includes a common gateway interface (CGI) at the server which converts protocol statements communicated between the server and I/O devices to application language statements for providing data to an application program coupled to the server. Most preferably, the application statements and protocol statements are constructed in integrated statements with an editor. The editor ensures that data identifiers in the application and protocol statements are compatible. The integrated statements are then parsed by the editor to segregate the protocol statements from the application statements. The protocol statements are downloaded in a file to a client program at an I/O device for processing. The application statements are stored in a file for use by the application. In this manner, generation of the files for client and application processing are automatically done without the user ensuring the correlation of the data fields in the two files.

### U.S. Pat. No. 5,956,483

### Inventor: Thomas A. Grate et al.

### Issued: Sep. 21, 1999

A function calling protocol and methodology allow local function calls to be embedded within HTML documents, using standard HTML (HyperText Markup Language) tags, such that a user can selectively initiate the function calls while viewing the documents with a standard World Wide Web (“Web”) browser. User-invocable functions are thereby added to Web documents without modification to either existing Web browsers or HTML. In accordance with the invention, when a user initiates a local function call (by clicking on a button or other content item from within the Web browser), an HTTP (Hypertext Transfer Protocol) POST message which contains the information for making the function call is generated by the standard Web browser. This message is routed from the Web browser to an application (which runs on the same computer as the browser) using a conventional Local Host service of the computer's TCP/IP stack. The application then uses the function-calling information to make the function call on the computer. In an electronic shopping embodiment, the application is an electronic shopping client application which allows Web users to securely engage in commerce with on-line merchants over the Internet, and the Web documents of the system include functions for performing actions such as displaying the contents of a shopping basket object or a wallet object to the user.

### U.S. Pat. No. 6,112,235

### Inventor: Jason J. Spofford

### Issued: Aug. 29, 2000

A method for remote management of a network hardware device using an industry standard internetwork protocol. A client and protocol stack are implemented on the computer network and an embedded server is installed on the network hardware device. Using the Hypertext Transfer Protocol (HTTP) and an available HTTP client, remote management of a hardware device is facilitated.

### U.S. Pat. No. 6,128,653

### Inventor: David del Val et al.

### Issued: Oct. 3, 2000

A method for employing a Hypertext Transfer Protocol (HTTP protocol) for transmitting streamed digital media data from a server. The server is configured for coupling to a client computer via a computer network. The method includes receiving at the server from the client an HTTP POST request. The POST request requests a first portion of the digital media data and includes a request header and a request entity-body. The request entity body includes a media command for causing the first portion of the digital media data to be sent from the server to the client. The method further includes sending an HTTP response to the client from the server. The HTTP response includes a response header and a response entity body. The response entity body includes at least a portion of the first portion of the digital media data.

### U.S. Pat. No. 6,138,150

### Inventor: Stephen R. Nichols et al.

### Issued: Oct. 24, 2000

A personal computer or workstation running a Web browser point and click interface is used to display and send information for remotely controlling a computer such as a mainframe. In the preferred embodiment, a web site or “home-page” is constructed on a secure HTTP (hyper text transfer protocol) server which comprises a Hardware Management Console (HMC). A user logs on to the Internet World Wide Web in a conventional manner by entering the address or uniform resource locator (URL) to connect to the secure HTTP server. Upon entry of a correct password the Hardware Management Console (HMC) home-page will be displayed. Icons representing various mainframe computer components are displayed which link to additional pages which the user can click on to monitor and control the mainframe computer. The color of the icons provide a summary of the status its representative component (e.g., a green icon indicates that the representative component is functioning is normally, red indicates an abnormal condition, and blue indicates that a message is available). Further, the user can change an automatic refresh rate for the browser stored at the server for a particular user identification (userid). Any action initiated by a remote web browser is reflected on the local Hardware Management Console (HMC) drag and drop interface and vice-versa.

### U.S. Pat. No. 6,151,625

### Inventor: Andrew G. Swales et al.

### Issued: Nov. 21, 2000

A control system includes an Internet web interface to a network of at least one programmable logic control system running an application program for controlling output devices in response to status of input devices. The Web interface runs Web pages from an Ethernet board coupled directly to the PLC back plane and includes an HTTP protocol interpreter, a PLC back plane driver, a TCP/IP stack, and an Ethernet board kernel. The Web interface provides access to the PLC back plane by a user at a remote location through the Internet. The interface translates the industry standard Ethernet, TCP/IP and HTTP protocols used on the Internet into data recognizable to the PLC. Using this interface, the user can retrieve all pertinent data regarding the operation of the programmable logic controller system.

While these computer software programs designed for data exchange communication interfacing may be suitable for the purposes for which they were designed, they would not be as suitable for the purposes of the present invention, as hereinafter described.

### SUMMARY OF THE PRESENT INVENTION

The present invention is a Hypertext Transfer Protocol Application Programming Interface (HTTP-API) for synchronizing a users desktop trading system with a stockbrokers remote system.

While there are many user desktop trading systems, these systems get out of sync with the actual trades performed for the client by stockbroker trading systems because client-side trading systems work independently from the stockbroker trading systems.

The users desktop trading system makes recommendations for buying and selling stocks at certain values. Users send these fill orders to their stockbroker trading system. Because of the volatility of the stock market the users orders may vary from its recommended positions. Fluctuations in price are inevitable and lead to discrepancies between an actual event and a recorded event. Furthermore, an order to buy or sell at a specific value may never occur. As an example, an order to buy ABC at 70½ would not occur at 71. While the trading system operated by the user would record the buy at 70½.

The present invention provides a method in the form of an Application Programming Interface (API) that would change any buy or sell order at a recommended value to a market order that is immediately sent to the broker.

In addition, the present invention anticipates the need for the stockbroker trading systems to provide its users with a retrievable and executable client-side HTTP-API. In such cases the stockbroker trading system will maintain the users account number, and machine specific information, such as CPU information, system user name, hard drive information, IP address etc, or any combination thereof. The combination of information would be fed into an algorithm that would generate a unique serial number that would be compared to a valid users account file to determine the validity of the access. It should also be considered that the storing of the user API information by the stockbroker trading system can occur on a timed fee basis.

The API would also be platform independent and programming language independent. The API would be a series of HTTP commands that will permit communication between languages of the World Wide Web, such as HTML, JAVA, ASP, etc,.

It is a primary objective of the present invention to provide HTTP-API method and apparatus whereby a client trading system can communicate with a stockbroker trading system to perform predetermined functions defined by the stockbroker trading system without having the absolute need for a client-side web browser, plugins or software languages contained within the stockbroker server system.

The following examples will further illustrate the scope of the present invention.

A user signs onto a stockbroker trading system that has the broker's web page. For the purpose of illustration it is assumed that the web page has a logon procedure whereby the user can gain access to account balance information, user portfolio list, buy/sell function enabling the user to purchase additional financial instruments and/or sell portfolio instruments and an order status function.

The present invention would record the HTTP commands and associated parameters for each of the previously stated functions, Logon, Account Balance, Portfolio List, Buy/Sell and Order Status. The commands will be stored whereby other software applications can incorporate these functions singularly or in total in any desired order.

### EXAMPLE 1

### Application that Monitors Client's Profit/Loss

This application will logon a user, retrieve their portfolio list, determine the profit or loss of each stock in the portfolio, and close out any positions which exceed a user defined profit or loss.

The application will do the following:

1) Prompt user for account username and password.

2) Send to the stockbroker server the “login” button HTTP transaction with username and password as parameters.

3) Retrieve the portfolio list showing profit/loss of each stock by sending the “portfolio List” button HTTP transaction to the server.

4) Parse out the profit/loss of each stock in portfolio.

5) Sell the stocks that show a profit or loss of 10% by sending the “Buy/Sell” button HTTP commands and parameters (including stock symbol) to close out the position.

6) Loop to step 3 until user terminates program.

### EXAMPLE 2

### Application to Automatically Placing Trades

This application will interface to a user's trading system program (ex. TradeStation®, Metastock®, TradeLab®, etc.) that generates buy/sell signals. The application will take the buy/sell signals generated by the trading system and automatically place the order with the client's broker. Furthermore, it also can provide the client with the following options:

a) ignore all “new order” buy/sell signals and only send “filled” order signals to broker as “Market” orders for immediate fill.

b) Converting “Limit” type orders to “Market if touched” orders.

c) Holding “Limit” type orders until market has touched “Limit” price and then sending to broker as “market” order.

d) Holding “Stop” type orders until market has touched the “Stop” price and then sending to broker as “Market” order.

e) Closing out all positions just before the closing of the market each day.

The application will do the following:

1) Prompt user for account username and password.

2) Send to the stockbroker server the “login” button HTTP transaction with username and password as parameters.

3) Send server the “Order Status” button HTTP transaction to retrieve status of all orders.

4) Display “Order Status” to user.

5) Wait for order signal from the trading system.

6) When order signal is received from trading system, do one or more of the following depending on user options.

a) Place order with broker using “Buy/Sell” button HTTP transaction with parameters that reflect this specific order. (Ex. Symbol, price, qty, order type).

b) Change order to “Market” type and send to broker.

c) Convert order to new type and send to broker.

d) hold order and monitor real time prices. When price moves to desired value, then send order to broker for execution. This is useful for “Stop”, “Limit”, “Market if Touched”, “Stop Limit”, and other synthetic orders.

7) Loop to step 3 until user terminates program.

### EXAMPLE 3

### Application to Monitor Headline News

This application will interface to a user predetermined news website and monitor the headline news and alert user if headline appears containing a user specified search term. For example, if the user is a tax specialist, they might specify a search term of “tax”. Subsequently, if any headline news stories are added to the web page containing the search term “tax” the user will be immediately notified with an alarm, or E-mail, or pager, and so on.

For the purpose of this example it is assumed that the news site has a button for “Headline News” and “Full Story” and that the HTTP transactions (HTTP command and parameters) have been previously recorded for each of these buttons and stored.

The application will do the following:

1) Prompt user for a search term (ex. “tax”).

2) Request all news headlines from server using the Headline News” button's HTTP transaction.

3) Search headlines for matching search term.

4) If search term is found in headline, then request the full story from server by sending the “Full Story” buttons's HTTP transaction.

5) Notify user a news story of interest has been found and the details are now ready to view.

6) Go to 2 until user exists.

A primary object of the present invention is to provide telecommunication application programming interface that will capture HTTP commands and parameters between a first computer and a second computer.

Another object of the present invention is to provide telecommunication application programming interface (API) that will capture HTTP commands and parameters between a first computer having a web browser and a second computer having a web page.

Yet another object of the present invention is to provide telecommunication application programming interface (API) that will capture HTTP commands and parameters exchanged between a first computer having a web browser accessing a function on a second computer having a web page.

Still yet another object of the present invention is to provide telecommunication application programming interface (API) that will capture HTTP commands and parameters exchanged between a first computer having a web browser accessing a function on a second computer having a web page and store the HTTP commands and parameters as a retrievable entity.

A further object of the present invention is to provide telecommunication application programming interface (API) that will capture all HTTP commands and parameters exchanged between a first computer having a web browser initiating a discrete function on a second computer's web page and storing the HTTP commands and parameters as a discrete retrievable entity within the first and/or second computers data storage media.

A yet further object of the present invention is to provide telecommunication application programming interface (API) that will store a plurality of uniquely identifiable retrievable discrete entities on a storage media comprising the HTTP commands and parameters associated with performing a function on a second computers web page.

A still yet further object of the present invention is to provide telecommunication application programming interface (API) that will store a plurality of uniquely identifiable retrievable discrete entities on a storage media comprising the HTTP commands and parameters associated with performing a function on a second computers server.

Another object of the present invention is to provide telecommunication application programming interface (API) that will store a plurality of uniquely identifiable retrievable discrete entities on a storage media comprising the HTTP) commands and parameters associated with performing a function on a second computers server that can be used by a first computer to perform a uniquely identifiable function through a second computer's server.

Yet another object of the present invention is to provide telecommunication application programming interface (API) that will store a plurality of uniquely identifiable retrievable discrete entities on a storage media comprising the HTTP commands and parameters associated with performing a function on a second computers server without the need of a web browser or web page.

Still yet another object of the present invention is to provide telecommunication application programming interface (API) comprised of prerecorded hypertext transfer protocol (HTTP) commands.

A further object object of the present invention is to provide HTTP-API for client-side and/or server side applications.

A yet further object of the present invention is to provide HTTP-API utilizing a common Messaging format for controlling the execution of client-side applications and/or server-side applications.

A still yet further object of the present invention is to provide HTTP-API between a client-side trading system and a server-side trading system.

Another object of the present invention is to provide HTTP-API for client-side trading system programmably modifying fill orders to market orders.

Yet another object of the present invention is to provide HTTP-API common Messaging format that can be stored on server-side stock trading systems.

Still yet another object of the present invention is to provide HTTP-API common Messaging format that can be retrieved from server-side stock trading systems on demand by client-side trading system.

A further object of the present invention is to provide HTTP-API common Messaging format that can be retrieved from server-side stock trading systems on demand by client-side trading system having verifiable encrypted identification.

Still yet another object of the present invention is to provide server-side stock trading systems having programming for querying client-side trading systems and generating verifiable identification whereby client-side trading systems can access unique client-side HTTP-API routines.

Additional objects of the present invention will appear as the description proceeds.

The present invention overcomes the shortcomings of the prior art by providing HTTP-API between client-side trading systems and server-side trading systems.

Also, the present invention provides HTTP-API for generating market orders from the client-side trading system upon client-side trading system generating fill orders.

In addition the present invention provides for server-side stock trading system querying client-side system generating verifiable identification for access to server-side stored client-side HTTP-API routines.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### LIST OF REFERENCE NUMERALS UTILIZED IN THE DRAWINGS

10 HTTP-API (hypertext transfer protocol application program interface)

12 client

14 user trading systems

16 Internet service provider

18 telecommunications

20 stockbroker system

22 stockbroker systems

24 algorithm communication access

26 stockbroker storage media

28 user communication equipment

30 client-side access

34 client-side web browser

36 client-side stockbroker access

38 client-side stockbroker signup

40 broker-side calculates identification

42 http-api resident

44 client-side http-api

46 broker-side http-api

48 client-side trading system transmits orders.

50 client-side system transmit

52 client trading system records transaction

54 client communicates with broker

56 client executes HTTP-API

58 client transmits market orders

60 broker fills market order

62 broker executes HTTP-API

64 broker retrieves market orders

### BRIEF DESCRIPTION OF THE DRAWING FIGURES

In order that the invention may be more fully understood, it will now be described, by way of example, with reference to the accompanying drawing in which:

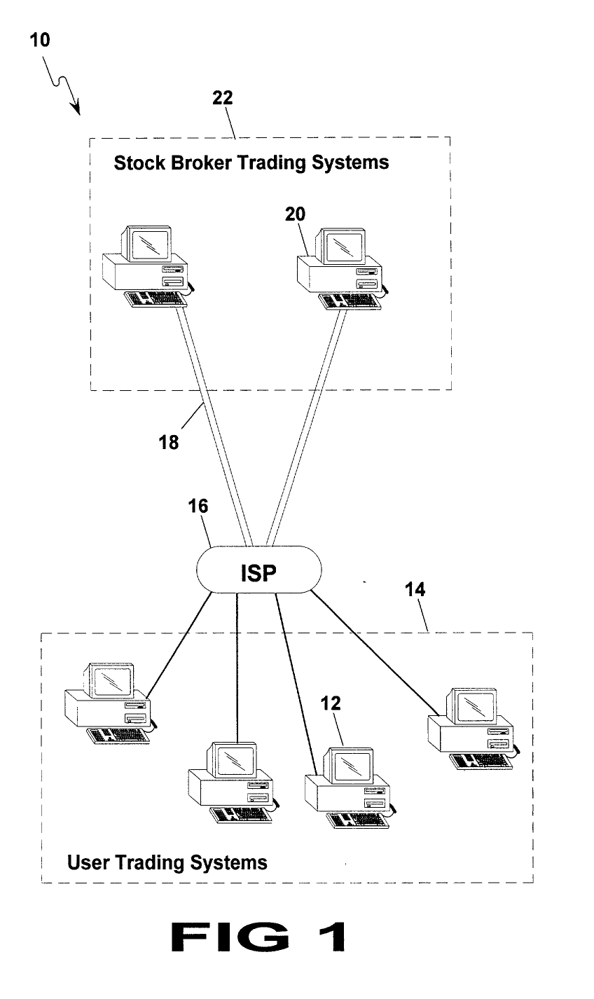

FIG. 1 is an illustrative view of the present invention showing communication between user trading systems and stockbroker trading systems;

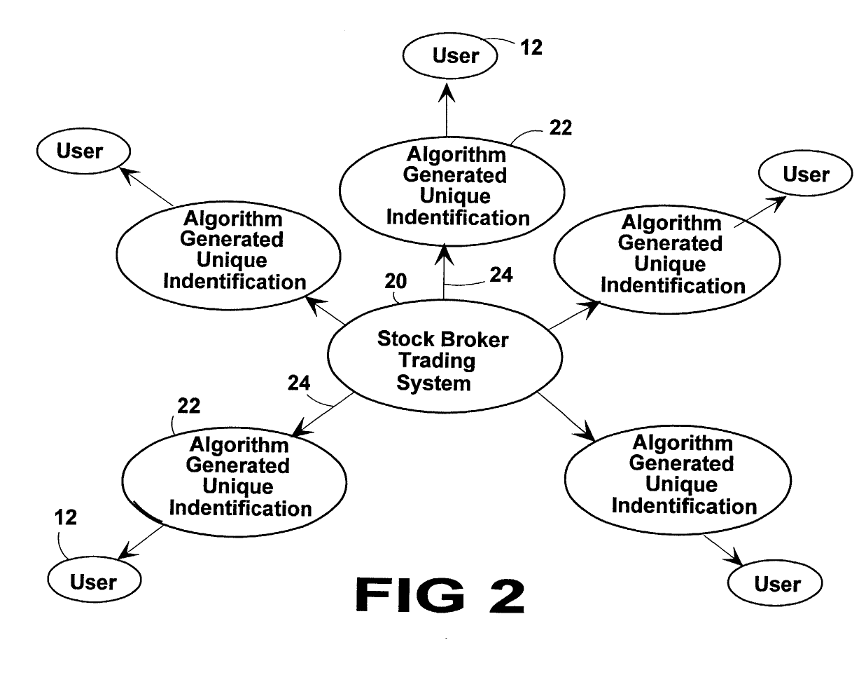

FIG. 2 is an illustrative view of a stockbroker trading system using an algorithm to uniquely identify user trading systems;

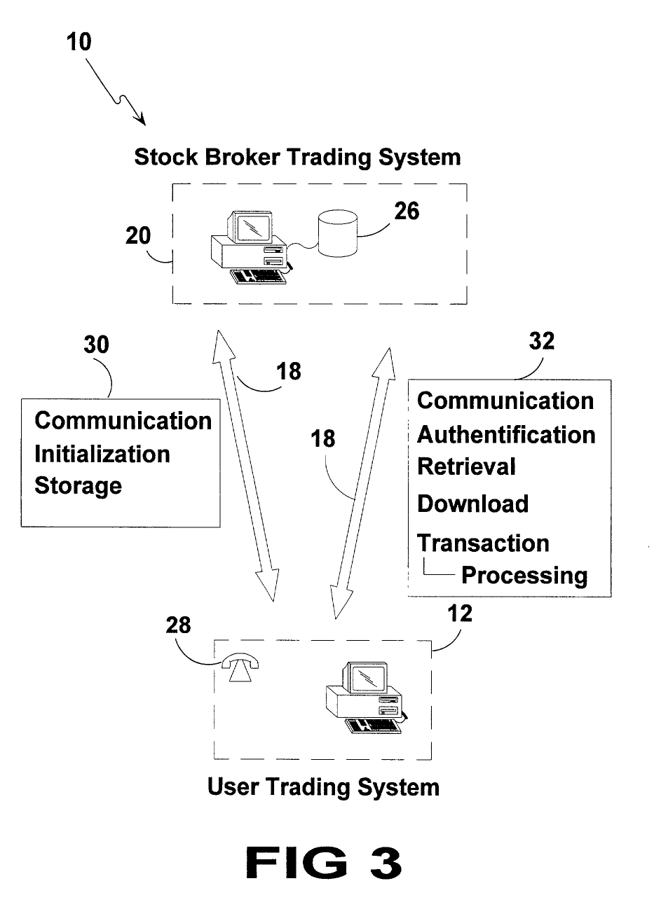

FIG. 3 is an illustrative view of the present invention showing a stockbroker trading system providing HTTP-API services for a user trading system.

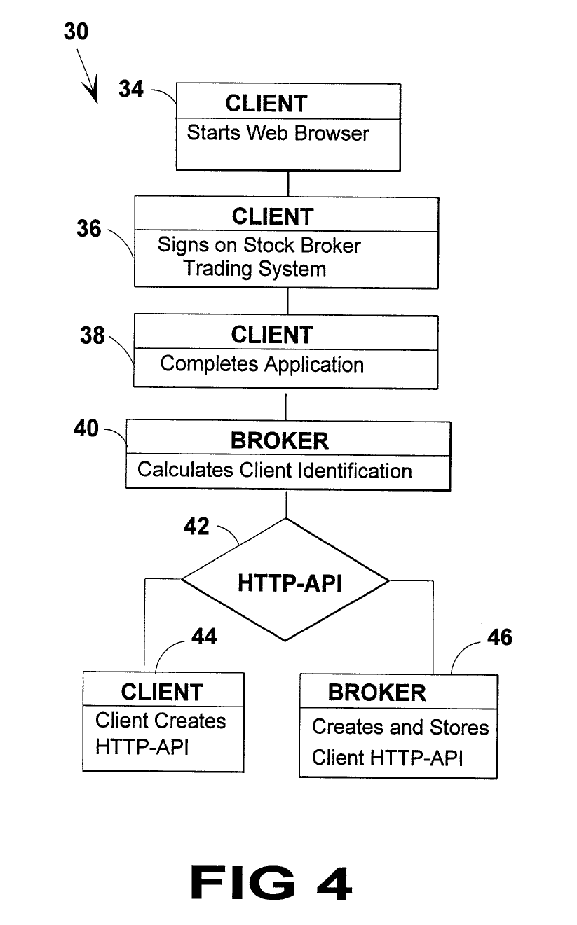

FIG. 4 is a flow chart of the initialization of HTTP-API service between a client-side trading system and a stockbroker trading system.

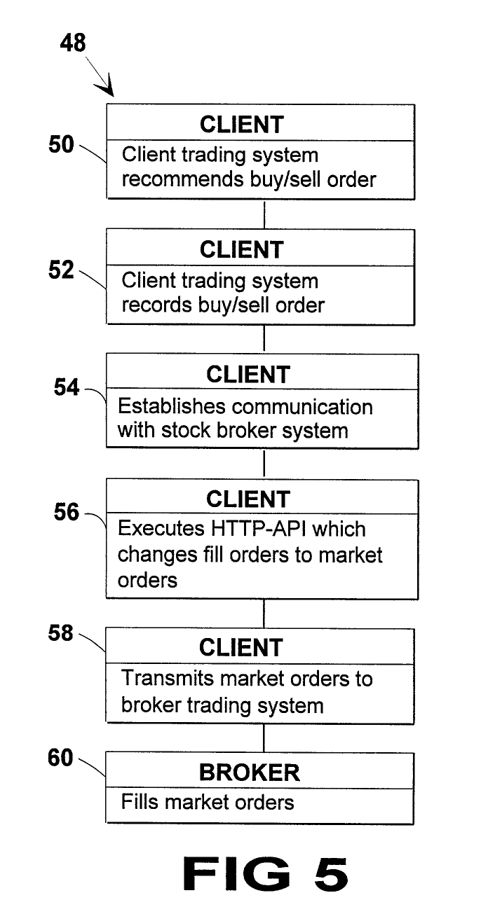

FIG. 5 is a flow chart of the processing steps applicable to client-side trading systems having resident programming control.

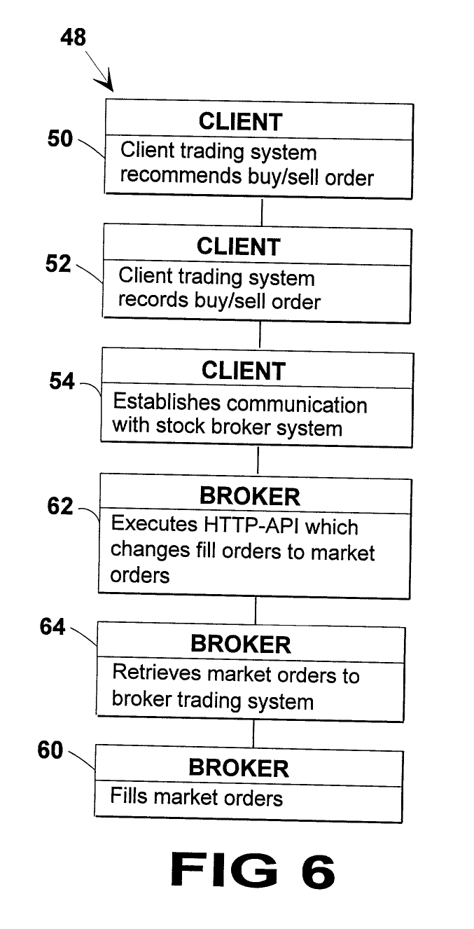

FIG. 6 is a flow chart of the processing steps applicable to broker-side systems having resident programming control.

### DETAILED DESCRIPTION OF THE PREFERRED EMBODIMENT

Turning now descriptively to the drawings in which similar reference characters denote similar elements throughout the drawing figures. FIG. 1 through FIG. 6 illustrate the HTTP-API between a user trading system and a stockbroker trading system of the present invention indicated generally by the numeral 10.

Referring to FIG. 1 users 14 having unique user trading systems communicate through an ISP 16 with stockbroker trading systems 22 via communication lines 18. The user 12 having a client-side trading system that makes recommendations to buy and/or sell stock at a given value transmits these orders to his/hers stockbroker trading system 20. While the user records the transaction as occurring, the reality is unpredictable.

Referring to FIG. 2, the user 12 contracts with the stockbroker trading system 20 to perform buy/sell orders. The stockbroker trading system creates an account for the user by querying the user's system to create a unique customer id based on the user's physical hardware. The stockbroker trading system 20, via communication 24 using algorithm 22 gathers information from the users system such as CPU information, system user name, hard drive information, IP address, etc., or any combination thereof to generate a user access code;

Referring to FIG. 3, the user 12 after communicating and contracting with a stockbroker trading system can record the HTTP commands that will provide access to the broker trading system 20. The user can store the HTTP commands within their system whereby the user can transmit their buy/sell orders without the need for a web browser or other stockbroker-side software. All that would be required is the client-side means of communication 28 with their ISP which would give them direct access via 18 to the stockbroker system 20. The user 12 could also contract with the broker 20 to provide an HTTP-API access. The user 12 establishes a communication with broker 20. After authentification, the user retrieves the HTTP-API and downloads to their system from the broker system having the user HTTP-API on storage media 26. Whereupon the user can perform transaction processing with the broker system;

Referring to FIG. 4, the client-side invokes a web browser 34 and signs onto a stockbroker trading system 36. The client completes the trading system application whereupon the broker trading system queries the user's system to generate a client identification 40. The client has the option of storing the HTTP commands within their own system where using the HTTP-API program can modify the stored HTTP commands to their own need 44. The client can also contract with the broker trading system to store the HTTP client commands;

Referring to FIG. 5, the client-side trading system recommends fill orders that are transmitted to the broker system 48. The client selectively runs the user trading system that recommends buy/sell orders 50. The client trading system records the transactions 52 whereupon the client establishes communication with the stockbroker system. The client side executes the HTTP-API that changes the fill orders to market orders. The market orders are transmitted to the broker system 58 where they are filled by the broker system 60.

Referring to FIG. 6, the client-side trading system recommends fill orders that are retrieved the broker system 66. The client selectively runs the user trading system that recommends buy/sell orders 50. The client trading system records the transactions 52 whereupon the client establishes communication with the stockbroker system. The broker-side executes the HTTP-API 62 that changes the fill orders to market orders. The market orders are retrieved by the broker system 64 where they are filled by the broker system 60.

What is claimed is new and desired to be protected by Letters Patent is set forth in the appended claims:

1. A computer software program for capturing the HTTP commands generate by a user through a web browser to a remote web server, the program comprising:
a) capturing HTTP commands;
b) storing HTTP commands;
c) retrieving HTTP commands; and
d) transmitting HTTP commands.

2. The system of claim 1, wherein said capturing HTTP commands includes processing for transcribing HTTP commands.

3. The system of claim 1, wherein said storing HTTP commands includes processing for recording the HTTP commands to a storage media.

4. The system of claim 1, wherein said retrieving HTTP commands includes processing for retrieving HTTP commands from a storage media.

5. The system of claim 1, wherein said transmitting HTTP commands includes processing for transmitting HTTP commands to the TCP/IP handler.

6. A computer software program having means for capturing the HTTP commands generate by a user through a web browser to a remote web server, the program comprising:
a) means for capturing HTTP commands;
b) means for storing HTTP commands;
c) means for retrieving HTTP commands; and
d) means for transmitting HTTP commands.

7. The system of claim 6, wherein said means for capturing includes processing means for transcribing HTTP commands.

8. The system of claim 6, wherein said means for storing includes processing means for recording the HTTP commands to a storage media.

9. The system of claim 6, wherein said means for retrieving includes processing means for retrieving HTTP commands from a storage media.

10. The system of claim 6, wherein said means for transmitting includes processing means for transmitting HTTP commands to the TCP/IP handler.

11. A HTTP-API method consisting of an interactive computer based program for recording HTTP commands between a client-side web browser and a web server.

12. The method of claim 11 further comprising processing means for storing the client-side web browser and web-server HTTP commands on a storage media.

13. The method of claim 11 further comprising processing means for retrieving an entity of HTTP session commands from a storage media.

14. The method of claim 11 further comprising processing means for transmitting an entity of HTTP session commands from a storage media.

15. A computer software program system that modifies a client-side trading system that modifies a client-side trading system output to market orders that are transmitted to a remote broker site, the program comprising:
a ) means for capturing stock orders;
b) means for modifying stock orders;
c) means for updating transaction records; and
d) means for transmitting market orders.

16. The system of claim 15, wherein said means for capturing stock orders includes processing means for seizing trading system transaction records.

17. The system of claim 15, wherein said means for modifying stock orders includes processing means for editing trading system transaction records.

18. The system of claim 15, wherein said means for updating stock orders includes processing means for changing trading system transaction records.

19. The system of claim 15, wherein said means for transmitting market orders includes processing means for establishing a telecommunications link with a remote stockbroker system for the purpose of transmitting transaction records to said remote site.

20. A computer software program system that modifies a client-side trading system that modifies a client-side trading system output to market orders that are transmitted to a remote broker site, the program comprising:
a) means for capturing stock orders;
b) means for modifying stock orders;
c) means for updating transaction records; and
d) means for transmitting market orders.

21. The system of claim 201, wherein said means for capturing stock orders includes processing means for seizing trading system transaction records.

22. The system of claim 20, wherein said means for modifying stock orders includes processing means for editing trading system transaction records.

23. The system of claim 20, wherein said means for updating stock orders includes processing means for changing trading system transaction records.

24. The system of claim 20, wherein said means for transmitting market orders includes processing means for establishing a telecommunications link with a remote stockbroker system for the purpose of transmitting transaction records to said remote site.

25. A computer software program that can be selectively initiated by a user that will act as an interface between a client-side trading system and a server-side trading system.

26. The computer software program of claim 25, having modified prerecorded HTTP commands for executing functions on a server-side trading system.

27. The computer software program of claim 25, having computer programming code for querying the user of said software for parameter information for completing the embedded HTTP commands.

28. The computer software program of claim 25, having computer programming code for modifying the output of a client-side trading system.

29. The computer software program of claim 25, having computer programming code for querying a user as to selected modifications to be made to the client-side trading system output data.

30. The computer software program of claim 25, having computer programming code for interfacing with a server-side trading system.
